(19) United States
(12) Patent Application Publication
(10) Pub. No.: US 2019/0279193 A1
(43) Pub. Date: Sep. 12, 2019

(54) SYSTEM AND METHOD FOR REAL-TIME COMMUNICATION OF CLIENT DEVICE AND USER INFORMATION

(71) Applicant: Synchrony Bank, Draper, UT (US)

(72) Inventors: Will Kievit, Stamford, CT (US); Sih Lee, Stamford, CT (US); Jake Miller, Stamford, CT (US); Trevor Grandle, Stamford, CT (US)

(21) Appl. No.: 16/291,904

(22) Filed: Mar. 4, 2019

Related U.S. Application Data
(60) Provisional application No. 62/639,411, filed on Mar. 6, 2018.

(51) Int. Cl. G06Q 20/32; G06Q 20/20

(52) U.S. Cl. CPC G06Q 20/327; G06Q 20/204

(57) ABSTRACT

In some embodiments, there is a method for communicating client device and user information based on position of a user at a facility, comprising: at a server including one or more processors, a database storing user information for the user and a memory storing instructions for execution by the one or more processors: receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners; storing the client device position information at the database; transmitting the at least one of: the client device position information and the user information to a point of sale (PoS) device operated by a merchant at the facility, the PoS device being configured to complete a transaction associated with the user.

### CROSS REFERENCE TO RELATED APPLICATION(S)

This application claims the benefit of U.S. Provisional Patent Application No. 62/639,411, filed on Mar. 6, 2018, which is incorporated herein by reference in its entirety.

### TECHNICAL FIELD

The present invention generally relates to position tracking and, more particularly, to a system and method for real-time communication of device and user information based on a device's position within an area relative to a listener (e.g., a beacon).

### SUMMARY

In some embodiments, there is a method for communicating client device and user information based on position of a user at a facility, comprising: at a server including one or more processors, a database storing user information for the user and a memory storing instructions for execution by the one or more processors: receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners; storing the client device position information at the database; transmitting the at least one of: the client device position information and the user information to a point of sale (“PoS”) device operated by a merchant at the facility, the PoS device being configured to complete a transaction associated with the user. A system comprising: one or more memory units each operable to store at least one program; and at least one processor communicatively coupled to the one or more memory units, in which the at least one program, when executed by the at least one processor, causes the at least one processor to perform the steps of: receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners; storing the client device position information at the database; transmitting the at least one of: the client device position information and the user information to a point of sale (PoS) device operated by a merchant at the facility, the PoS device being configured to complete a transaction associated with the user.

In some embodiments, there is a non-transitory computer readable storage medium having stored thereon computer-executable instructions which, when executed by a processor, perform the steps of: receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners; storing the client device position information at the database; transmitting the at least one of: the client device position information and the user information to a point of sale (PoS) device operated by a merchant at the facility, the PoS device being configured to complete a transaction associated with the user.

### BRIEF DESCRIPTION OF THE DRAWINGS

For a better understanding of the disclosed embodiments as well as additional aspects and embodiments thereof, reference should be made to the Description of Embodiments below, in conjunction with the following drawings in which like reference numerals refer to corresponding parts throughout the figures.

In the drawings:

FIG. 1 is a block diagram illustrating an example client-server environment, in accordance with some embodiments.

FIG. 2 is a block diagram illustrating a server system, in accordance with some embodiments.

FIG. 3 is a flow diagram illustrating a method for communicating client device and user information based on position of a user at a facility, in accordance with some embodiments.

FIGS. 4A-B are exemplary diagrams illustrating a client device, a point of sale (“PoS”) device and listeners (implemented as beacons) positioned within a facility, in accordance with some embodiments.

### DETAILED DESCRIPTION

Today, as most customers transition from shopping at conventional brick-and-mortar stores to online-shopping, merchants and financial institutions are constantly considering and implementing different techniques to improve the customer experience at brick-and-mortar stores and to influence customer purchase behavior while customers are at their stores. However, merchants and financial institutions are limited in their ability, individually, to influence customer purchase behavior for a few reasons. First, financial institutions are unable to ascertain a customer or account holder's intent to make a purchase while at a merchant's store until after the merchant attempts to authorize a payment with that same financial institution. Second, merchants are unable to ascertain what payment instruments or tender types a customer has available to them until the customer volunteers a payment instrument to pay for a purchase. Because this event occurs at the end of the interaction between the merchant and customer, the merchant has little opportunity to influence the customer's purchase behavior.

Thus there is a need for methods and systems that provides real-time communication between a financial institution and the merchant for all customer information relevant to both parties, such as customer location within a store and customer purchase information (e.g., customer identifying information, payment instrument information and purchase history), before the customer initiates a transaction to purchase goods or services. By using such methods and systems, both parties could influence customer behavior by suggesting other goods or services to purchase or by offering directed incentives or rewards to purchase goods or services, to the customer, while the customer is still shopping in the store.

In some embodiments, the methods and systems provide real-time communication between a financial institution and the merchant for all customer data relevant to both parties. In methods and systems provide the ability to track customers at merchant locations and leverage the position of the customer in the store, using position-tracking technology described herein. Based on the location of the customer and other contextual information, the customer's intent (to browse, purchase, etc.) can be inferred. For example, a customer that is located in front of a point of sale (PoS) device may intend to make a purchase, whereas, a customer that is located in a kayaking isle of an outdoor apparel and gear store, after previously purchasing a kayak, may be interested in purchasing kayak accessories. With user (or client device) position information and user information (e.g., purchase history, loyalty/reward card account numbers, first name, last name, date of birth, gender, ethnicity), the financial institution and merchant can leverage such information to alter customer purchase behavior, such as by incentivizing the purchase of add-on goods or services or by tender steering (e.g., using a certain purchase instrument to conduct the transaction)

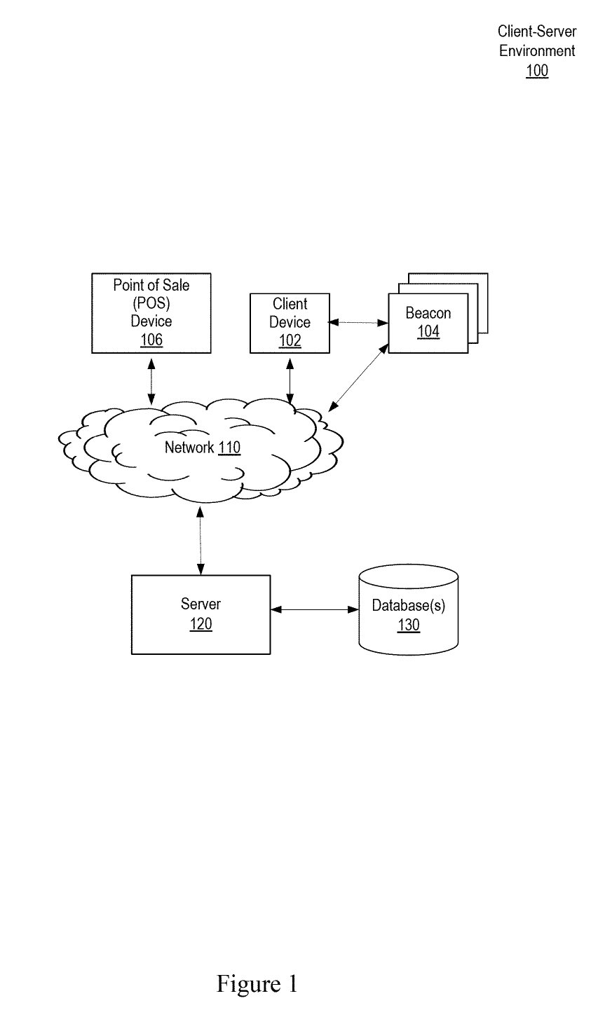

FIG. 1 is a block diagram illustrating an example client-server environment 100 for communication of client device and user information based on based on position of a user, according to some embodiments. In FIG. 1, the client-server environment 100 includes a server 120, a client device 102, one or more listeners 104, and a point of sale (“PoS”) device 106. One or more communication networks 110 interconnect these components. The communications network 110 may be any of a variety of networks, including local area networks (“LAN”), wide area networks (“WAN”), wireless networks, wired networks, the Internet, or a combination of such networks. In some embodiments, the client device 102 may detect wireless signals from, or connect to, one or more listeners 104 directly via a wireless connection (e.g., Bluetooth).

According to some embodiments, the client device 102 includes a client application to connect to the server 120 and a user interface to interact with a user. The client application, after execution by the client device 102, is configured to transmit data to and/or receives data from the server 120 and/or the listener 104. The client device 102 may be any computer or other electronic device that is capable of communicating with the server 120. Examples of the client device 102 include, without limitation, desktop and notebook computers, and mobile devices such as mobile phones, smart phones, and personal digital assistants.

In the drawings, each of the listener(s) 104 has been illustrated as being implemented as a beacon. However, in alternate embodiments, one or more of the listener(s) 104 may be implemented using other types of wireless communication technology. For example, one or more of the listener(s) 104 may be implemented using ultrasonic sound to determine location. In some embodiments, the listener 104 is a small indoor/outdoor positioning device (e.g., a beacon) that, in some embodiments, uses Low Energy BLUETOOTH® (BLE) technology to connect with client device 102 and server 120. However, it is contemplated that, in other embodiments, the listener 104 may be any device configured to provide positional data to another device. The listener 104 may transmit proximity data (e.g., client device identifying information and/or listener identifying information) to the client device 102 and/or the server 120. In some embodiments, the listener 104 is configured to generate proximity data, including client device identifying information and listener identifying information, and transmit the proximity data to the server device 120, indicating a client device 102 was in proximity to the listener 104 from a client device 102, for further processing by the server device 120, as described below in more detail. A client device 102 may be considered in close proximity to the listener 104 when the listener 104 can wirelessly communicate information with the client device 102. In alternative embodiments, the listener 104 is configured to transmit proximity data, such as listener identifying information, to the client device 102. In response to receiving the proximity data, the client device 102 may transmit the proximity data received from the listener 104, as well as the client device identifying information to the server 120 for further processing.

In some embodiments, one or more listeners 104 may transmit signals to the client device 102 used, by the client device 102, to determine a position of the client device 102 relative to the one or more listeners 104, such as a distance from the one or more listeners 104. Examples of signals may include acoustic, radio, electromagnetic radiation, or light, among others. In some embodiments, the client device 102 may determine that one or more listeners 104 is in close proximity by determining that a signal strength of the one or transmitted signals for a particular listener 104 exceeds a signal strength threshold. In some embodiments, in accordance with a determination that one or more listeners 104 is in close proximity, the client device 102 may transmit proximity data (e.g., client device identifying information and/or listener identifying information) to server 120.

In some embodiments, the PoS device 106 may be a computing device controlled by a merchant. In some embodiments, the PoS device 106 may be a computing device configured to complete a transaction with a customer. Examples of the PoS device 106 include, without limitation, cash registers, desktop and notebook computers, and mobile devices such as mobile phones, smart phones, and personal digital assistants.

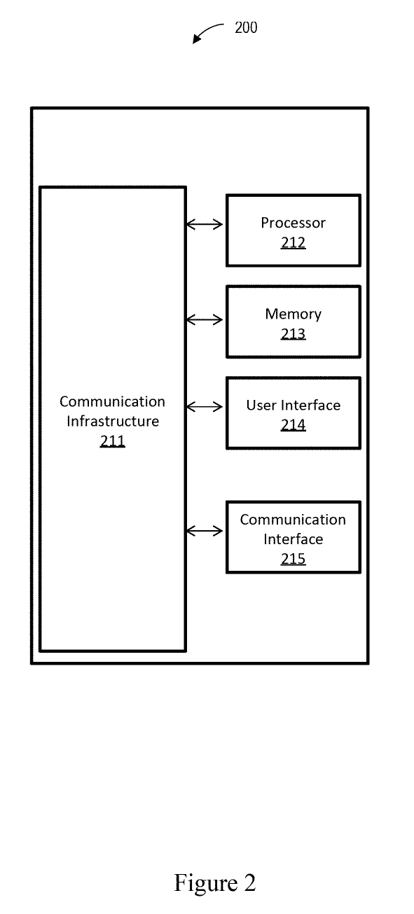

FIG. 2 shows a block diagram that illustrates an electronic device 200 for performing one or more methods according to one or more embodiments of the present invention.

Electronic device 200 may be any computing device for receiving data from a user or a remote device, processing data, generating and/or displaying data, and transmitting data to a user or a remote device. Electronic device 200 may include communication infrastructure 211, processor 212, memory 213, user interface 214 and communication interface 215.

Processor 212 may be any type of processor, including but not limited to a special purpose or a general-purpose digital signal processor. In this embodiment, processor 212 is connected to a communication infrastructure 211 (for example, a bus or network). Various software implementations are described in terms of this exemplary computer system.

Memory 213 may include at least one of: random access memory (RAM), a hard disk drive and a removable storage drive, such as a floppy disk drive, a magnetic tape drive, or an optical disk drive, etc. The removable storage drive reads from and/or writes to a removable storage unit. The removable storage unit can be a floppy disk, a magnetic tape, an optical disk, etc., which is read by and written to a removable storage drive. Memory 213 may include a computer usable storage medium having stored therein computer software programs and/or data to perform any of the computing functions of electronic device 200. Computer software programs (also called computer control logic), when executed, enable electronic device 200 to implement embodiments of the present invention as discussed herein. Accordingly, such computer software programs represent controllers of electronic device 200. Memory 213 may include one or more datastores that store imaging data, software files or any other types of data files (e.g., database 130 as shown in FIG. 1).

User interface 214 may be a program that controls a display (not shown) of electronic device 200. User interface 214 may include one or more peripheral user interface components, such as a keyboard or a mouse. The user may use the peripheral user interface components to interact with electronic device 200. User interface 214 may receive user inputs, such as mouse inputs or keyboard inputs from the mouse or keyboard user interface components. User interface 214 may display imaging data on the display of electronic device 200.

Communication interface 215 allows imaging data to be transferred between electronic device 200 and remote devices. Examples of communication interface 215 may include a modem, a network interface (such as an Ethernet card), a communication port, a Personal Computer Memory Card International Association (PCMCIA) slot and card, etc. Imaging data transferred via communication interface 215 are in the form of signals, which may be electronic, electromagnetic, optical, or other signals capable of being transmitted or received by communication interface. These signals are provided to or received from communication interface 215.

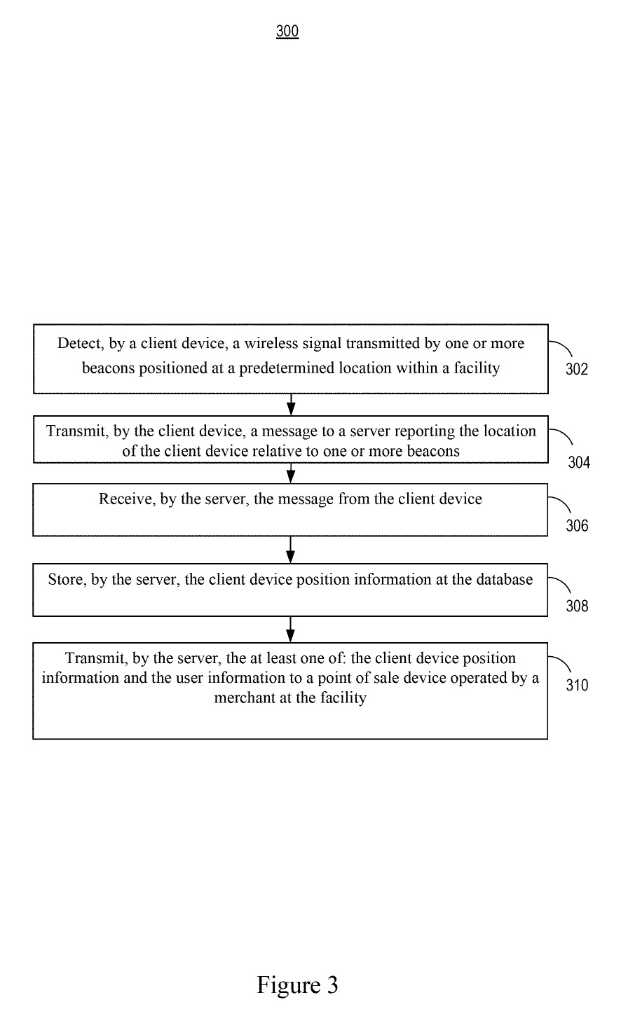

FIG. 3 is a flow diagram illustrating a method 300 for communicating client device and user information based on position of a user at a facility in accordance with some implementations. The method 300 is performed at one or more computing devices (e.g., server 120). Some operations in method 300 are, optionally, combined and/or the order of some operations is, optionally, changed. FIGS. 1, 2 and 4A-4B are used to illustrate the method in FIG. 3.

As described below, the method 300 provides an intuitive way to communicate client device and user information based on position of a user at a facility. The method improves the purchasing experience for the customer and merchant by reducing the amount of time necessary to complete a transaction from initial presentation of a financial instrument by the customer. The method also improves the user experience by providing targeted information for the customer at the facility before the user initiates a purchase transaction. For example, with user (or client device) position information and user information (e.g., purchase history), the financial institution and merchant can leverage such information to alter customer purchase behavior, such as by recommending certain products that may be of interest to the user and/or providing dynamic pricing information for the products; incentivizing the purchase of add-on goods or services; incentivizing the use of loyalty/rewards programs; or by tender steering (e.g., using a certain purchase instrument to conduct the transaction)

Initially, a user may create a financial account managed by a financial institution. The financial institution may issue a payment instrument associated with the financial account to the user to allow the user to conduct purchases with merchants. The financial institution may track user information (e.g., user identifying information, financial instrument information, user purchase history) of the user, via user information received by the server 120, and store the user information in database 130.

In some embodiments, a user of a client device 102 invokes a client application on the client device 102, such as by selecting a client application icon associated with the client application on a display of the client device 102. In some embodiments, the client application is associated with a financial institution hosting one or more servers (e.g., the server 120), and, once invoked, configures the client device 102 to connect to the server 120. In some embodiments, the client application must be configured to access and share location information with server 120, as well as detect wireless devices transmitting a wireless signal (e.g., a Bluetooth signal). In some embodiments, the user authenticates (e.g., provides a user name and password) at the client application to associate the user with the client application and indirectly the client device 102.

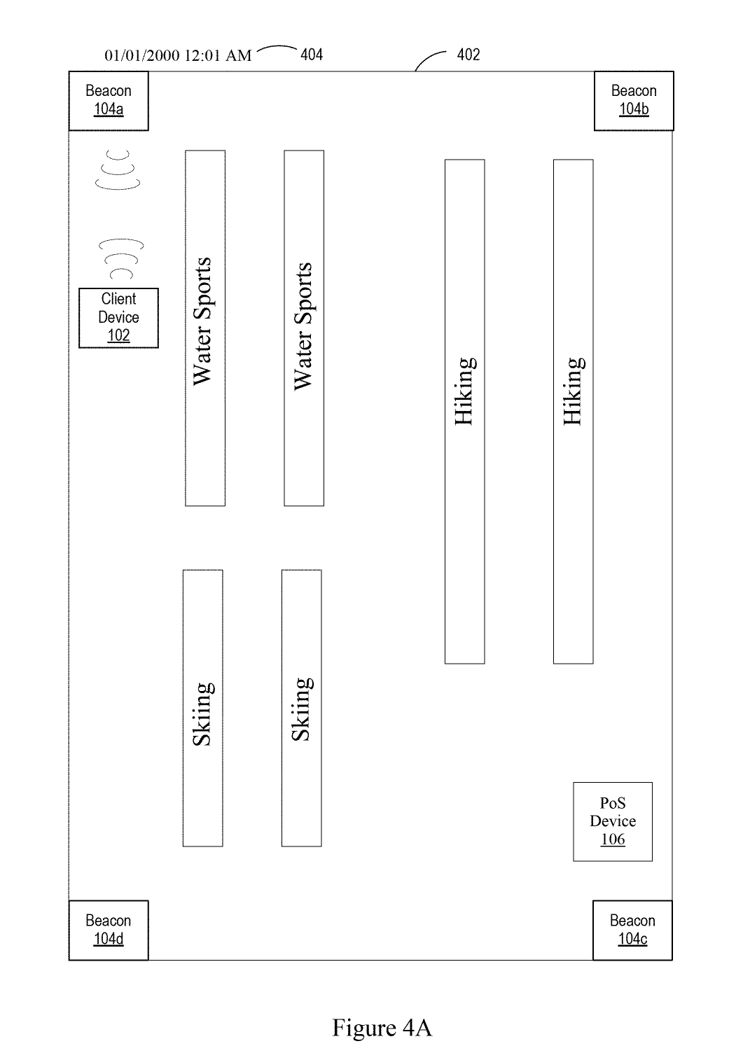

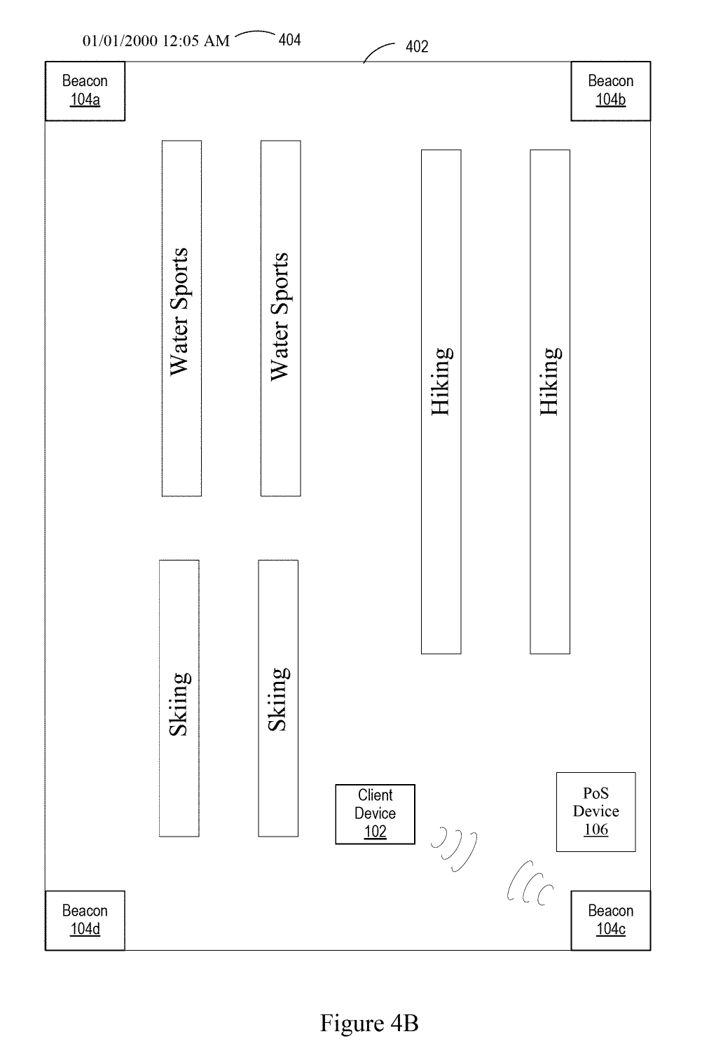

At step 302 of FIG. 3, the client device 102 detects a wireless signal transmitted by one or more of the listeners 104a-104d positioned at a predetermined location within a facility, such as when the mobile electronic device is in proximity to the listener 104. For example, in FIGS. 4A-4B, there is shown a facility 402 for outdoor apparel and gear that is owned by a merchant. Listeners 104a-104d are positioned at different predetermined locations within the facility 402, such that each listener is associated with a certain area or section of the facility 402. In this example, listener 104a is positioned near the water sports section, listener 104b is positioned near the hiking section, listener 104c is positioned near PoS device 106 and listener 104d is positioned near the skiing section. The client device 102 can determine that it is in the listener's respective section when the client device 102 is capable of receiving wireless signals from any of the listeners 104a-104d. In FIG. 4A, the client device 102 detects a wireless signal from listener 104a while the client device 102 is in the water sports section of the facility 402. In FIG. 4B, the client device 102 detects a wireless signal from listener 104c while the client device 102 is near the PoS device 106 of the facility 402.

At step 304 of FIG. 3, the client device 102 transmits a message to the server 120 reporting the location of the client device 102 relative to one or more listeners 104a-104d associated with the facility 402. In some embodiments, the message comprises client device position information. The client device position information may include a client device ID associated with the client device 102; one or more unique listener IDs associated with one or more listeners (which may be included in the wireless signal transmitted by each of the listeners 104a-104d); and/or a timestamp indicating when a client device detected a wireless signal. For example, after receiving the wireless signal from listener 104a as shown in FIG. 4A, at the time indicated at clock 404, the client device 102 transmits a message to the server 120 that includes a client device ID (e.g., “Customer 123”), a listener ID (e.g., “water sports beacon”) and a timestamp (“Jan. 1, 2000 at 12:01 AM”). In another example, after receiving the wireless signal from listener 104c as shown in FIG. 4B, at the time indicated at clock 404, the client device 102 transmits a message to the server 120 that includes a client device ID (e.g., “Customer 123”), a listener ID (e.g., “PoS beacon”) and a timestamp (e.g., “Jan. 1, 2000 at 12:01 AM”).

At step 306 of FIG. 3, the server 120 receives the message from the client device 102.

At step 308 of FIG. 3, the server 120 stores the client device position information at the database 130. In some embodiments, the client device position information may be associated with the user information, such that, upon request by a merchant, the associated client device position information and user information can be retrieved.

At step 310 of FIG. 3, the server 120 transmits the at least one of: the client device position information and the user information to a point of sale device 106 operated by a merchant at the facility 402. A merchant can then use the transmitted information to identify or determine the intent of the user. For example, in the example shown in FIG. 4A, because the client device 102 (and the user) is located in the water sports section, the client device position information received by the PoS device 106 may include information indicating that the user is in the water sports section for approximately 2 minutes. In addition, user information received by the PoS device 106 may include information indicating that the user previously purchased a kayak. Based on this information, it may be inferred that the user intends to purchase kayaking accessories, and is having trouble selecting a certain accessory, as inferred from the user standing in the water sports section for approximately 2 minutes. In this example, the server 120 may transmit client device position information (e.g., “the customer has been in the water sports section for 2 minutes”) and/or user information (e.g., purchase history (“a kayak was purchased recently”), or intent determination information (e.g., “the customer purchased a kayak recently and may be looking for kayak accessories”)). Using this information, the merchant can decide how to approach the user and offer valuable and targeted advice of interest to the user. In another example shown in FIG. 4B, because the client device 102 (and the user) is located near the PoS device 106, the client device position information received by the PoS device 106 may include information indicating that the user was in the water sports section earlier, as shown in FIG. 4A. In addition, user information received by the PoS device 106 may include information indicating that the user previously purchased a kayak. Based on this information, it may be inferred that the user intends to purchase some kayak accessories. With this information, the merchant can offer certain incentives to the user, such as a discount for using a specific financial instrument to purchase the kayak accessories, or suggest additional products to purchase before checking out.

In some embodiments, the server 120 may be configured to transmit client device information to the PoS device 106 in response to receiving a message from the client device 102 indicating that the user is in the facility. In other embodiments, a merchant can request that the server 120 transmit all customer information associated with specific listeners associated with the merchant's facilities. In these embodiments, the server 120 is configured to receive a request from the PoS device 106, operated by a merchant, to transmit any client device position information associated with one or more unique listener IDs (e.g., listeners 104a-104d). In response, the server 120 is configured to select, from the database 130, a first set of client device position information associated with the one or more unique listener IDs; and transmit the first set of client device position information associated with the one or more unique listener IDs to the PoS device 106. For example, a merchant might be interested in determining the most popular areas of the merchant's store so the user might request all client device position information related to any of listeners 104a-104d. By analyzing the client device position information, the merchant can identify the most popular listeners to better understand which areas in his store are the most popular. In other embodiments, a merchant can request the server 120 to transmit current client device position information to understand where users are in the store, in real-time. In these embodiments, the server 120 is configured to receive a request from the PoS device 106, operated by a merchant, to transmit any current client device position information associated with one or more unique listener IDs (e.g., listeners 104a-104d). In response, the server 120 is configured to select, from the database 130, a second set of client device position information associated with one or more unique listener IDs (e.g., listeners 104a-104d) and that includes a timestamp that meets a time threshold (e.g., timestamps dated less than 15 minutes before receipt of the request from the merchant); and transmit the second set of client device position information associated with the user to the PoS device 106. Using this information, a merchant can determine the currently popular areas of the store that might require attention from idle staff members in other less popular areas. The PoS Device 106 may display the client device position information as a graphical representation. For example, the PoS device 106 may display client device position information as a dot, aligned on a 2-D or 3D floor plan illustrating the store layout.

In some embodiments, based on certain criteria, the server 120 is configured to selectively provide purchase instrument information to the PoS device 106 if the user is at the PoS device 106 or provide client device and user information if the user is at another location within the store. If the user is at the PoS device 106, by having the purchase instrument information in advance of checkout, the merchant can perform some of the checkout procedures, such as pre-authorization, before the user presents the purchase instrument for use, thereby reducing the time necessary to complete the purchase transaction. If the user is at another location, the server 120 is configured to report customer information that can aid a merchant in improving the customer experience for that specific customer. In these embodiments, the server 120 is configured to determine whether the one or more messages received from the client device 102 indicates that the client device 102 meets point of sale (PoS) proximity criteria, wherein the PoS proximity criteria is met when the message includes a unique listener ID representative of a listener at the PoS device 106 (e.g., listener 104c in FIG. 4B). In accordance with a determination that the client device 102 meets PoS proximity criteria, the server 120 is configured to transmit, to the PoS device 106, the payment instrument information (e.g., credit card information, first name, last name, account number, date of birth, loyalty/rewards points information, credit bard balance, payment history, delinquency history) associated with the user. In accordance with a determination that the client device does not meet PoS proximity criteria: the server 120 is configured to transmit, to the PoS device 106, the client device position information and the user information associated with the user.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the disclosure and its practical applications, to thereby enable others skilled in the art to best utilize the various embodiments with various modifications as are suited to the particular use contemplated.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Throughout the preceding description, various embodiments are described within the context of smart phone cameras, tablets and the like. This is purely for convenience of explanation and is not intended to limit the claims that follow.

What is claimed is:

1. A method for communicating client device and user information based on position of a user at a facility, comprising:
at a server including one or more processors, a database storing user information for the user and a memory storing instructions for execution by the one or more processors:
receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners;
storing the client device position information at the database;
transmitting the at least one of: the client device position information and the user information to a point of sale (PoS) device operated by a merchant at the facility, the PoS device being configured to complete a transaction associated with the user.

2. The method of claim 1, further comprising:
at the server:
receiving a request from the PoS device, operated by a merchant, to transmit any client device position information associated with one or more unique listener IDs;
selecting, from the database, a first set of client device position information associated with the one or more unique listener IDs; and
transmitting the first set of client device position information associated with the one or more unique listener IDs to the PoS device.

3. The method of claim 1, further comprising:
at the server:
receiving a request from the PoS device, operated by a merchant, to transmit any current client device position information associated with one or more unique listener IDs;
selecting, from the database, a second set of client device position information associated with one or more unique listener IDs and that includes a timestamp that meets a time threshold; and
transmitting the second set of client device position information associated with the user to the PoS device.

4. The method of claim 1, further comprising:
at the server:
determining whether the one or more messages received from the client device indicates that the client device meets point of sale (PoS) proximity criteria, wherein the PoS proximity criteria is met when the message includes a unique listener ID representative of a listener at the PoS device;
in accordance with a determination that the client device meets PoS proximity criteria:
retrieving, from the database, payment instrument information associated with the user; and transmitting, to the PoS device, the payment instrument information associated with the user;
in accordance with a determination that the client device does not meet PoS proximity criteria:
transmitting, to the PoS device, the client device position information and the user information.

5. The method of claim 1, wherein the user information includes payment instrument information and purchase history associated with the user.

6. The method of claim 1, wherein the user information include an indication of client intent to purchase an item.

7. A system comprising:
one or more memory units each operable to store at least one program; and
at least one processor communicatively coupled to the one or more memory units, in which the at least one program, when executed by the at least one processor, causes the at least one processor to perform the steps of:
receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners;
storing the client device position information at the database;
transmitting the at least one of: the client device position information and the user information to a point of sale (PoS) device operated by a merchant at the facility, the PoS device being configured to complete a transaction associated with the user.

8. The system of claim 7, the processor is further caused to perform the step of:
receiving a request from the PoS device, operated by a merchant, to transmit any client device position information associated with one or more unique listener IDs;
selecting, from the database, a first set of client device position information associated with the one or more unique listener IDs; and
transmitting the first set of client device position information associated with the one or more unique listener IDs to the PoS device.

9. The system of claim 7, the processor is further caused to perform the step of:
receiving a request from the PoS device, operated by a merchant, to transmit any current client device position information associated with one or more unique listener IDs;
selecting, from the database, a second set of client device position information associated with one or more unique listener IDs and that includes a timestamp that meets a time threshold; and
transmitting the second set of client device position information associated with the user to the PoS device.

10. The system of claim 7, the processor is further caused to perform the step of:
determining whether the one or more messages received from the client device indicates that the client device meets point of sale (PoS) proximity criteria, wherein the PoS proximity criteria is met when the message includes a unique listener ID representative of a listener at the PoS device;
in accordance with a determination that the client device meets PoS proximity criteria:
retrieving, from the database, payment instrument information associated with the user; and transmitting, to the PoS device, the payment instrument information associated with the user;
in accordance with a determination that the client device does not meet PoS proximity criteria:
transmitting, to the PoS device, the client device position information and the user information.

11. The system of claim 7, wherein the user information includes payment instrument information and purchase history associated with the user.

12. The system of claim 7, wherein the user information include an indication of client intent to purchase an item.

13. A non-transitory computer readable storage medium having stored thereon computer-executable instructions which, when executed by a processor, perform the steps of: receiving, from a client device operated by the user, one or more messages reporting a location of the client device relative to one or more listeners associated with the facility, wherein the one or more messages comprises client device position information including one or more unique listener IDs associated with one or more listeners, a client device ID associated with the client device and a timestamp indicating when the client device detected a wireless signal from the one or more listeners;
storing the client device position information at the database;
transmitting the at least one of: the client device position information and the user information to a point of sale (PoS) device operated by a merchant at the facility, the PoS device being configured to complete a transaction associated with the user.

14. The non-transitory computer readable storage medium of claim 13, wherein the processor is further caused to perform the step of:
receiving a request from the PoS device, operated by a merchant, to transmit any client device position information associated with one or more unique listener IDs;
selecting, from the database, a first set of client device position information associated with the one or more unique listener IDs; and
transmitting the first set of client device position information associated with the one or more unique listener IDs to the PoS device.

15. The non-transitory computer readable storage medium of claim 13, wherein the processor is further caused to perform the step of:
receiving a request from the PoS device, operated by a merchant, to transmit any current client device position information associated with one or more unique listener IDs;
selecting, from the database, a second set of client device position information associated with one or more unique listener IDs and that includes a timestamp that meets a time threshold; and
transmitting the second set of client device position information associated with the user to the PoS device.

16. The non-transitory computer readable storage medium of claim 13, wherein the processor is further caused to perform the step of:
determining whether the one or more messages received from the client device indicates that the client device meets point of sale (PoS) proximity criteria, wherein the PoS proximity criteria is met when the message includes a unique listener ID representative of a listener at the PoS device;
in accordance with a determination that the client device meets PoS proximity criteria:
retrieving, from the database, payment instrument information associated with the user; and transmitting, to the PoS device, the payment instrument information associated with the user;
in accordance with a determination that the client device does not meet PoS proximity criteria:
transmitting, to the PoS device, the client device position information and the user information.

17. The non-transitory computer readable storage medium of claim 13, wherein the user information includes payment instrument information and purchase history associated with the user.

18. The non-transitory computer readable storage medium of claim 13, wherein the user information include an indication of client intent to purchase an item.
